(19) United States
(12) Patent Application Publication
(10) Pub. No.: US 2025/0296481 A1
(43) Pub. Date: Sep. 25, 2025

(54) WADING CONTROL METHOD OF FUEL CELL VEHICLE AND WADING SYSTEM OF FUEL CELL VEHICLE

(71) Applicants: Hyundai Motor Company, Seoul (KR); Kia Corporation, Seoul (KR)

(72) Inventors: Gwan Ho Baek, Incheon (KR); Hyun Min Chae, Yogin-Si (KR)

(21) Appl. No.: 18/938,510

(22) Filed: Nov. 6, 2024

(30) Foreign Application Priority Data
Mar. 22, 2024 (KR) 10-2024-0039757

(51) Int. Cl. B60L 58/40; B60L 3/00; B60L 58/12; B60L 58/30; B60W 40/06; H01M 8/04119

(52) U.S. Cl. CPC B60L 58/40; B60L 3/0053; B60L 58/12; B60L 58/30; B60W 40/06; H01M 8/04179; B60L 2240/64; B60L 2240/66

(57) ABSTRACT

Proposed is a wading control method of a fuel cell vehicle. The wading control method includes determining, by a controller, whether a fuel cell vehicle requires a wading function, when it is determined that the wading function is required, determining, by the controller, a driving available distance based on a battery state of charge (SOC), determining, by the controller, whether wading is possible, and closing, by the controller, one or more of an air cut-off valve and an air pressure control valve in preparation for performing the wading function.

### CROSS REFERENCE TO RELATED APPLICATIONS

The present application claims priority to Korean Patent Application No. 10-2024-0039757, filed on Mar. 22, 2024, the entire contents of which is incorporated herein for all purposes by this reference.

### BACKGROUND

Fuel cells are devices supplied with hydrogen and air from the outside part to generate electrical energy through electrochemistry reaction inside a fuel cell stack, and fuel cells may be used as a power source in various fields such as fuel cell vehicles (FCEV), fuel cells for power generation, etc.

On the other hand, in special cases, a vehicle may pass a stream or a river, or in the case of intensive rainfall, a vehicle may be driven through water flowing toward a road or in a flooded road.

In the case of an internal combustion engine vehicle, when water flows into an engine through an air inlet/air outlet, driving the vehicle is impossible due to the flooded engine and there may be a great risk.

However, in the case of an electric vehicle, the vehicle is driven by a battery and a motor, and the battery and the motor may have sealed structures to prevent external moisture from penetrating therein so that there may be less risk of water flooding.

In the case of a fuel cell vehicle, the fuel cell vehicle may have a battery and a motor of a sealed structure like an electric vehicle, but an air supply system, which is provided to supply air to a fuel cell stack or discharge air outward of the vehicle, communicates with the outside and the fuel cell stack is likely to be flooded by water.

Therefore, a technique that can protect the fuel cell stack of the fuel cell vehicle from flooding is required in special situations where a vehicle crosses a river or a stream or a road is flooded by intensive rainfall.

The matters described in this Background section are only for enhancement of understanding of the background of the disclosure, and should not be taken as acknowledgement that they correspond to prior art already known to those skilled in the art.

### SUMMARY

The present disclosure has been proposed to solve the above problems and is intended to provide a wading control method of a fuel cell vehicle and a wading system of a fuel cell vehicle, which enables a fuel cell vehicle to cross a river or a stream or to be temporarily driven in a road flooded or at risk of flooding due to intensive rainfall.

A wading control method of a fuel cell vehicle may comprise: determining, by a controller of the fuel cell vehicle, whether the fuel cell vehicle requires a wading operation; based on a determination that the wading operation is required and based on a state of charge (SOC) of a battery of the fuel cell vehicle, determining, by the controller, a driving available distance of the fuel cell vehicle; based on the driving available distance and based on a driving route of the fuel cell vehicle, determining, by the controller, whether the wading operation is granted; based on a determination that the wading operation is granted, closing, by the controller, at least one of an air cut-off valve of a fuel cell stack of the fuel cell vehicle or an air pressure control valve associated with the fuel cell stack; and after the closing, performing, by the controller, the wading operation while driving, using power provided by the battery, the fuel cell vehicle along the driving route.

The determining whether the wading operation is granted may comprise: comparing the driving available distance with a wading distance associated with the driving route, wherein the wading distance is determined based on the driving route provided by a navigation device.

The determining whether the wading operation is granted may comprise: comparing the driving available distance with a user-input wading distance, wherein the user-input wading distance is an estimated wading distance set by a user of the fuel cell vehicle, and the estimate wading distance is associated with a driving route of the fuel cell vehicle selected by the user.

The determining whether the wading operation is granted may comprise: based on a determination that the wading operation is prohibited, charging the battery to increase the SOC of the battery for the wading operation.

The closing may comprise: closing the air pressure control valve and pressurizing the fuel cell stack by driving an air compressor for preparing the wading operation; and after the pressurizing the fuel cell stack, closing the air cut-off valve and stopping driving of the air compressor.

The closing of the air cut-off valve may comprise: closing, based on an inner pressure of the fuel cell stack satisfying a set pressure value, the air cut-off valve.

The method may further comprise: after the closing, performing the wading operation; and after the wading operation is ended, removing, by the controller, moisture from an air supply system of the fuel cell vehicle.

The removing of the moisture from the air supply system may comprise: removing moisture from the air supply system for a time duration before driving an air compressor; and after the time duration, removing remaining moisture from the air supply system by driving the air compressor.

The removing of the remaining moisture from the air supply system may comprise: determining the remaining moisture in the air supply system by driving the air compressor at a reference rotation speed after the time duration, and adjusting, based on the determined remaining moisture, a rotation speed of the air compressor.

The removing of the moisture from the air supply system may comprise opening the air pressure control valve while maintaining the closing of the air cut-off valve.

The method may further comprise: after the removing of the moisture from the air supply system, opening the air cut-off valve to supply air to the fuel cell stack to generate an output power by using the fuel cell stack.

An apparatus of a fuel cell vehicle may comprise: an air supply system comprising at least one of: an air cut-off valve of a fuel cell stack of the fuel cell vehicle, an air pressure control valve associated with the fuel cell stack, or an air compressor associated with the fuel cell stack; and a controller configured to: determine whether the fuel cell vehicle requires a wading operation, based on a determination that the wading operation is required and based on a state of charge (SOC) of a battery of the fuel cell vehicle, determine a driving available distance of the fuel cell vehicle, and based on a determination that the wading operation is granted, close at least one of the air cut-off valve or the air pressure control valve in preparation for performing the wading operation within the driving available distance.

The controller may be configured to determine whether the wading operation is granted by: comparing the driving available distance with a wading distance associated with a driving route of the fuel cell vehicle, wherein the wading distance is determined based on the driving route provided by a navigation device; or comparing the driving available distance with a user-input wading distance, wherein the user-input wading distance is an estimated wading distance set by a user of the fuel cell vehicle, and the estimate wading distance is associated with a driving route of the fuel cell vehicle selected by the user.

The controller may be configured to charge, based on a determination that the wading operation is prohibited, the battery to increase the SOC of the battery to perform the wading operation.

The controller may be configured to remove, after the wading operation is ended, moisture from the air supply system by driving the air compressor.

The controller may be configured to: during a first time period, close the air pressure control valve and pressurize the fuel cell stack by driving the air compressor for preparing the wading operation; and during a second time period after the first time period, close the air cut-off valve while maintaining the closing of the air pressure control valve, wherein the wading operation is performed during the second time period.

A vehicle may comprise: a first power source comprising a fuel cell stack; a second power source comprising a battery; an air supply system comprising at least one of: a first valve configured to cut-off air supply to the fuel cell stack, or an air pressure control valve associated with the fuel cell stack; and a controller configured to: based on a determination that a wading operation is required for the vehicle and based on a state of charge (SOC) of the battery, determine a driving available distance of the vehicle, and based on a determination that the wading operation is granted, close at least one of the first valve or the air pressure control valve in preparation for performing the wading operation within the driving available distance.

The controller may be configured to charge the battery to increase the SOC of the battery to perform the wading operation.

The controller may be configured to remove, after the wading operation is ended, moisture from the air supply system by driving an air compressor.

The controller may be configured to: during a first time period, close the air pressure control valve and pressurize the fuel cell stack by driving an air compressor for preparing the wading operation; and during a second time period after the first time period, close the first valve while maintaining the closing of the air pressure control valve, wherein the wading operation is performed during the second time period.

According to the wading control method of a fuel cell vehicle and the wading system of a fuel cell vehicle of the present disclosure, there are advantages of enabling the vehicle to cross a river or a stream or to be temporarily driven in a flooded road or a road at a risk of flooding due to intensive rainfall to reduce damages caused by flooding.

### BRIEF DESCRIPTION OF THE DRAWINGS

FIG. 1 and FIG. 2 are flowcharts illustrating a wading control method of a fuel cell vehicle according to an example of the present disclosure.

FIG. 3 is a block diagram schematically illustrating a wading system of a fuel cell vehicle according to an example of the present disclosure.

FIG. 4 is a view illustrating operation states of components over time to describe a wading function of the fuel cell vehicle.

### DETAILED DESCRIPTION

Hereafter, various aspects of the present disclosure will be described in detail with reference to the accompanying drawings and the same or similar components are given the same reference numerals regardless of the numbers of figures and are not repeatedly described.

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

A controller may include a communication device communicating with other controllers or a sensor to control one or more functions/operations in charge, a memory storing an operation a logic command, and input/output information, and/or one or more processors performing determination, calculation, and decision necessary for controlling the function in charge.

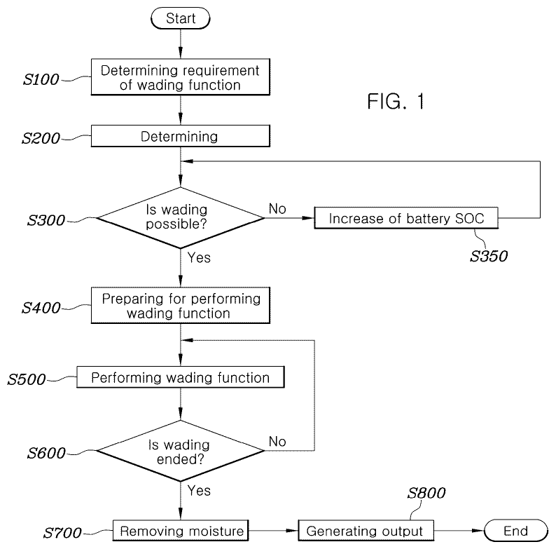

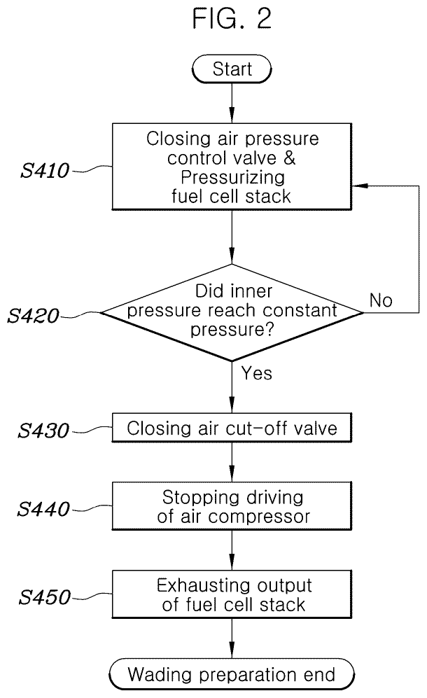

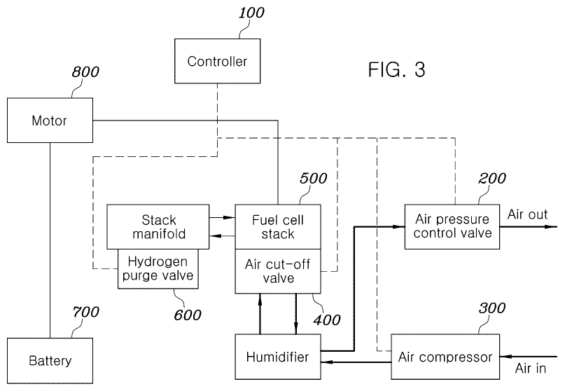

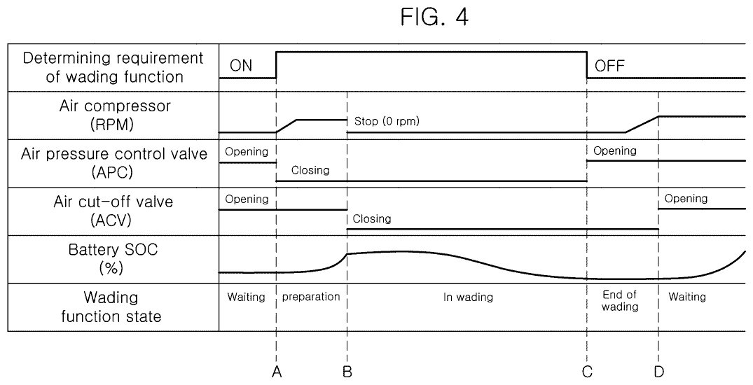

FIG. 1 and FIG. 2 are flowcharts illustrating an example wading control method of a fuel cell vehicle. FIG. 3 is a block diagram schematically illustrating an example wading system of the fuel cell vehicle. FIG. 4 is a view illustrating operation states of components over time to describe a wading function of the fuel cell vehicle.

In the present disclosure, a wading function described below may refer to a function performed when a fuel cell vehicle drives or crosses a place where water is stagnant, such as a river, lake, etc. Therefore, wading can mean an act of a vehicle driving or crossing a place where water is stagnant.

Hereinafter, the present disclosure will be described with reference to FIGS. 1 to 4.

According to the present disclosure, a wading control method of a fuel cell vehicle may include: determining (S100), by a controller (e.g., a controller 100 of the fuel cell vehicle), whether the fuel cell vehicle requires a wading function; based on a determination that the wading function is required, determining (S200), by the controller, a driving available distance based on a battery state of charge (SOC); determining (S300), by the controller, whether wading is possible; and closing, by the controller, one or more of an air cut-off valve 400 and an air pressure control valve 200 in preparation for performing a wading operation.

In the determining (S100) of whether the fuel cell vehicle requires the wading function (e.g., the determining step (S100) may be triggered, for example, if a wading function performance request signal is input into the controller 100 by a user), the controller 100 may determine whether wading function is required. The fuel cell vehicle may include a specific sensor for the controller to determine whether wading function is required (e.g., if at least one sensor of the fuel cell vehicle detects the height of the water level beneath the fuel cell vehicle). For example, it can be determined whether the fuel cell vehicle requires the wading function through a measured value of a water level sensor which can determine a water level of a place where the vehicle is currently located.

The controller may determine whether wading function is required by measuring the driving of the air compressor 300 and the pressure of an air outlet of a fuel cell stack 500. A sensor that measures the degree of slip of a wheel of the fuel cell vehicle and the degree of resistance by a fluid of the fuel cell vehicle is installed in the fuel cell vehicle to determine whether wading function is required.

The fuel cell vehicle may receive an indication of the current weather situation or the future prediction weather situation (e.g., when the fuel cell vehicle receives an indication of a situation in which a disaster warning such as a flood warning is issued in a place where the vehicle is currently located), the controller may determine that the fuel cell vehicle requires the wading function now or in future.

Meanwhile, if the controller determines that the fuel cell vehicle requires the wading function, the controller may determine a driving available distance of the fuel cell vehicle based on the state of charge (SOC) of an alternate power source (e.g., a battery 700 of the fuel cell vehicle).

The situation in which the wading function is required may be for the fuel cell vehicle to be driven in an environment where there is a risk of flooding, so electrical power generation of the fuel cell stack 500 may need to be stopped when the wading function of the fuel cell vehicle is activated and the wading operation of the fuel cell vehicle is performed. Accordingly, the driving of the fuel cell vehicle may be performed by driving a motor 800 with electric power provided by the battery 700 that may be installed in the fuel cell vehicle. The controller may determine a driving available distance based on a current state of charge (SOC) of the battery 700 of the fuel cell vehicle, for example, to determine a drivable distance by the fuel cell vehicle during the wading operation.

After the determining (S200) of the SOC of the battery 700 of the fuel cell vehicle, the controller may determine whether wading of the fuel cell vehicle is possible (S300). Whether wading of the fuel cell vehicle is possible may, for example, be determined as follows.

In the determining (S300) of whether wading of the fuel cell vehicle is possible, the controller 100 may determine whether wading is possible by comparing the driving available distance and a wading distance based on a route provided by a navigation device.

For example, if it is determined that the driving available distance of the fuel cell vehicle by the battery 700 is 5 km and the wading distance based on the navigation location information is 3 km, the controller may determine that the fuel cell vehicle can perform the wading operation to drive the wading distance, and the controller may determine that wading of the fuel cell vehicle is possible.

On the other hand, if it is determined that the driving available distance of the fuel cell vehicle by the battery 700 is 2 km and the wading distance based on the navigation location information is 3 km, the fuel cell vehicle is expected to stop in the middle of wading so the controller may determine that the wading of the fuel cell vehicle is prohibited via the route corresponding to the wading distance. In this case, the controller may generate a control signal to control the navigation device to find an alternate route to a safe alternate destination within the driving available distance (e.g., 2 km) from the current location of the fuel cell vehicle, and the controller may generate a notification to the user of the fuel cell vehicle indicating the wading operation is prohibited and/or indicating the alternate route to the safe alternate destination. The notification may be provided via a display of the fuel cell vehicle and/or a speaker of the fuel cell vehicle.

Even when the driving available distance of the fuel cell vehicle by the battery 700 is higher than the wading distance, an actual movable distance of the fuel cell vehicle may be shorter than the driving available distance by the fluid resistance so the controller 100 may determine whether wading of the fuel cell vehicle is possible while setting a safety margin of about 10-20% as a safety factor of the fuel cell vehicle.

In the determining (S300) of whether wading is possible, the controller 100 may determine whether wading is possible by comparing the driving available distance and a user-input wading distance.

For example, if the user does not attempt to perform wading through the shortest distance but determines to drive via an alternate route (e.g., detour a partial distance), a wading distance to be driven according to the decision of the user may be input to the controller. If a wading distance to eb driven according to the decision of the user is input to the controller, the controller may determine whether wading is possible by comparing the driving available distance and the user-input wading distance.

In an example, if it is determined that the driving available distance of the fuel cell vehicle by the battery 700 is 5 km and the user-input wading distance is 3 km, the controller may determine that the fuel cell vehicle can perform the wading operation to wade via the alternate route associated with user-input wading distance, and the controller may determine that wading of the fuel cell vehicle is possible.

If it is determined that the driving available distance of the fuel cell vehicle by the battery 700 is 2 km and the user-input wading distance is 3 km, the fuel cell vehicle is expected to stop in the middle of wading so the controller may determine that the wading function of the fuel cell vehicle is prohibited.

Even when the driving available distance of the fuel cell vehicle by the battery 700 is higher than the user-input wading distance, an actual movable distance of the fuel cell vehicle may be shorter than the driving available distance by the fluid resistance so the controller may determine whether wading of the fuel cell vehicle is possible while setting a safety margin of about 10˜20% as a safety factor of the fuel cell vehicle. For example, even if it is determined that the driving available distance of the fuel cell vehicle by the battery 700 is 2 km, the actual movable distance of the fuel cell vehicle may be about 1.6 km-1.8 km (e.g., 10-20% less than 2 km).

If it is finally determined that wading of the fuel cell vehicle is possible (Yes of S300), the controller may prepare to perform the wading operation of the fuel cell vehicle (S400).

In order to prepare for the wading operation of the fuel cell vehicle, the controller may close one or more of the air cut-off valve 400, a hydrogen purge valve 600, and the air pressure control valve 200, thereby blocking the inside portion of the fuel cell stack 500 from the external portion, and may prepare to drive the fuel cell vehicle using the battery 700 and the motor 800. In an example, the air cut-off valve 400 may be a valve that may allow or cut off air supplied to the fuel cell stack and/or adjust a flow amount of air by adjusting an opening amount of the valve.

If it is determined that wading is impossible (No of S300), the controller may increase the SOC of the battery 700 for the wading (S350). In an example, the controller 100 may calculate a SOC shortfall of the battery 700 for the wading and control the fuel cell stack 500 to generate an output power to fill the SOC shortfall, and the generated output power may be used to charge the battery 700 so that the battery SOC may be increased.

If the battery SOC is increased, the controller may determine again whether wading is possible (S300), and if it is determined that wading is possible, the vehicle may enter the preparing ($400) of the performance of the wading operation.

The preparing (S400) of the performance of the wading operation may be performed by closing one or more of the air cut-off valve 400 and the air pressure control valve 200 to seal the fuel cell stack 500 to protect the fuel cell stack 500 from water damage during the wading operation. For example, as shown in FIG. 2, the controller 100 may close the air pressure control valve 200 and pressurize the fuel cell stack 500 by driving the air compressor 300 for preparing the wading function (S410); may close the air cut-off valve 400 (S430); and may stop driving of the air compressor 300 from (S440). The controller 100 may exhaust output of the fuel cell stack 500 (S450) after the stopping of driving of the air compressor 300.

The pressurizing (S410) of the fuel cell stack may be performed by closing an air outlet of the fuel cell stack 500 by closing the air pressure control valve 200, and (e.g., at the same time,) by pressurizing the fuel cell stack 500 by driving the air compressor 300. The pressurizing the fuel cell stack 500 in advance before the wading may easily remove moisture remaining in a flow path by inner air pressure when valves and the like are opened after the end of the wading and prevent moisture from flowing into the fuel cell stack.

Pressurizing of the fuel cell stack 500 may be performed until the inside pressure of the fuel cell stack has a constant pressure or more, and the controller 100 may determine whether the inside pressure of the fuel cell stack 500 reaches the constant pressure (S420). If the inside pressure of the fuel cell stack 500 reaches the constant pressure or more, the controller 100 may close the air cut-off valve 400 to seal the fuel cell stack 500 and block any water that may flow from the outside. For example, the constant pressure may be a value preset higher than the atmospheric pressure, and the controller 100 may allow the inner pressure of the fuel cell stack 500 to be maintained with the constant pressure or more to prevent moisture from entering the fuel cell stack 500 after the wading operation.

If the air cut-off valve 400 is closed, the controller 100 may stop driving the air compressor 300, and may determine whether the hydrogen purge valve 600 provided in the fuel cell stack 500 is closed. Except when a hydrogen purge is required in the fuel cell stack 500, the hydrogen purge valve 600 may normally be maintained in a closed state, but when the wading operation is performed and the hydrogen purge valve 600 is opened, there may be a risk that moisture flows into the fuel cell stack 500 so it may be necessary to additionally determine a state of the hydrogen purge valve 600 in advance. Accordingly, the controller 100 may determine whether the fuel cell stack 500 is completely closed by determining whether the hydrogen purge valve 600 provided in the fuel cell stack 500 is also closed after closing the air cut-off valve 400. However, the above example is provided for only illustrative purposes and is not necessarily limited thereto.

The controller 100 may exhaust the output generated by the chemical reaction (S450), the chemical reaction occurring inside the fuel cell stack 500. When air flows into the fuel cell stack 500, oxygen in the air reacts with hydrogen in the anode to generate the output, and the controller 100 may perform converter voltage control to control a converter (BHDC) to exhaust the output of the fuel cell stack 500. Accordingly, the driving of the fuel cell stack 500 may be stopped when performing the wading operation.

If the preparing (S400) of the wading operation of the fuel cell stack 500 is ended, the wading control method may further perform one or more operations, for example, including: performing (S500) the wading function; and removing (S700) moisture in an air supply system, by the controller 100, by driving the air compressor 300 when determining that the wading operation has been terminated. The wading operation may be performed via an autonomous driving control of the fuel cell vehicle (e.g., at the same time while performing the wading of the fuel cell vehicle based on information collected by a sensor provided in the fuel cell vehicle) or may be performed by pressing, by the user, an accelerator pedal in the fuel cell vehicle.

After the performance of the wading operation, the controller 100 may determine whether the wading operation is ended (S600). For example, the controller 100 may determine whether the wading operation is ended by using the water level sensor provided in the fuel cell vehicle or by using a separately provided determination logic. However, the above description is provided for only illustrative purposes and is not necessarily limited thereto. If it is determined that the wading is ended (Yes of S600), the controller 100 may remove moisture in the air supply system by driving the air compressor 300 (S700).

In an example, before the air compressor 300 is driven, the controller 100 may wait for an amount of time so that moisture flowing into the air supply system is naturally removed. The amount of time may be a time duration set for moisture that flows into the air supply system after the wading is ended to be naturally discharged (e.g., by gravity) or the amount of time may be variously set depending on the specification of the air supply system. However, the above description is provided for only illustrative purposes and is not necessarily limited thereto.

After the amount of time has been elapsed, the controller 100 may remove the remaining moisture in the air supply system by driving the air compressor 300. In an example, after the amount of time has been elapsed, the controller 100 may determine an amount of the remaining moisture in the air supply system by driving the air compressor 300 below a reference rotation speed. The reference rotation speed may be a rotation speed (RPM) set for the air compressor 300 to be operated at a minimum. For example, as the remaining moisture increases, the pressure generated by the air compressor 300 increases, so the controller 100 may determine an approximate amount of the remaining moisture in the air supply system by measuring the pressure of the air outlet of the fuel cell stack 500. However, the above description is provided for only illustrative purposes and is not necessarily limited thereto, and the controller 100 may determine the approximate amount of the remaining moisture in the air supply system by determining the current change according to the rotation speed of the air compressor 300.

If the amount of remaining moisture is determined, the controller 100 may adjust the rotation speed of the air compressor 300 depending on the determined amount of remaining moisture. If the amount of the remaining moisture is large (e.g., greater than or equal to a threshold value), the controller 100 may increase the rotation speed of the air compressor 300 so that the remaining moisture in the air supply system is forcibly discharged outward. If the amount of the remaining moisture in the air supply system is small (e.g., less than the threshold value), the controller 100 may enable the air compressor 300 to be driven at a low rotation speed or not to be driven.

In the process of the removing (S700) the moisture in the air supply system, if the closing of the air cut-off valve 400 is maintained, the air formed by the air compressor 300 is prevented from flowing into the fuel cell stack 500 but is guided to be all bypassed to flow toward the air outlet of the fuel cell stack 500, and if the air pressure control valve 200 is opened, the bypassed air may be discharged outward with the remaining water in the air supply system.

After the removing (S700) the moisture in the air supply system, the controller may generate (S800) an output power by supplying air into the fuel cell stack 500 by opening the air cut-off valve 400. If the moisture in the air supply system is removed, it is possible to normally drive the fuel cell stack 500, and the degree of opening of the air cut-off valve 400 may be adjusted according to a required output of the fuel cell stack 500 to generate the output by the chemical reaction in the fuel cell stack.

A status diagram with respect to the above description is shown in FIG. 4.

If it is determined that the wading function of the fuel cell vehicle is required at the time point A, the air pressure control valve 200 may be closed and the air compressor 300 may be driven to pressurize the inner pressure of the fuel cell stack 500 until the inner pressure reaches the constant pressure. Since the output is generated from the fuel cell stack 500 until the inner pressure reaches the constant pressure, the generated output power may be applied to the battery 700 for charging so that the SOC of the battery 700 is increased, and the air cut-off valve 400 may be closed at the time point B where the constant pressure is generated. At this point, the driving of the air compressor 300 may be stopped and the inner portion of the fuel cell stack 500 may be sealed from the outside, so that the fuel cell vehicle may perform the wading operation. If it is determined that the wading operation of the fuel cell vehicle is ended at the time point C, the controller 100 may open the air pressure control valve 200 and maintain the closed state of the air cut-off valve 400 to discharge the moisture flowing into the air supply system. After the amount of time has been elapsed, the controller 100 may drive the air compressor 300 to determine the amount of the remaining moisture in the air supply system and may adjust the speed of the air compressor 300 depending on the amount of the remaining moisture. The time point D may be a state in which the wading function of the fuel cell vehicle is fully ended due to the discharge of all of the remaining moisture and may be the wading function activation standby state.

According to one or more aspects of the present disclosure, the wading system of the fuel cell vehicle may include the air supply system and the controller. The air supply system may include one or more selected from the air cut-off valve 400, the air pressure control valve 200, and the air compressor 300 The controller 100 may determine whether the fuel cell vehicle requires the wading function, determine a driving available distance based on the battery SOC if it is determined that the wading function is required, and close one or more of the air cut-off valve 400 and the air pressure control valve 200 to prepare to perform the wading operation.

The controller 100 may determine whether a wading operation is possible by comparing the driving available distance and the wading distance based on a route of the navigation device, or by comparing the driving available distance and the user-input wading distance.

If it is determined that the wading is impossible or prohibited, the controller 100 may increase the battery SOC for the wading.

After the wading operation of the fuel cell vehicle is ended, the controller 100 may drive the air compressor 300 to remove the moisture from the air supply system.

In order to achieve one or more objectives of the present disclosure, there is provided a wading control method of a fuel cell vehicle, the wading control method may include: determining, by a controller, whether a fuel cell vehicle requires a wading function; when it is determined that the wading function is required, determining, by the controller, a driving available distance based on a battery state of charge (SOC); determining, by the controller, whether wading is possible; and closing, by the controller, one or more of an air cut-off valve and an air pressure control valve in preparation for performing the wading function.

For example, for the determining, by the controller, whether wading is possible, the controller may determine whether wading is possible by comparing the driving available distance and a wading distance based on a navigation.

For example, for the determining, by the controller, whether wading is possible, the controller may determine whether wading is possible by comparing the driving available distance and a user-input wading distance.

For example, for the determining, by the controller, whether wading is possible, when it is determined that the wading is impossible, the controller may increase the battery state of charge (SOC) for the wading.

For example, the closing may include: closing the air pressure control valve and pressurizing a fuel cell stack by driving an air compressor for preparing the wading function; closing the air cut-off valve; and stopping driving of the air compressor.

For example, the closing of the air cut-off valve may include closing the air cut-off valve when an inner pressure of the fuel cell stack is equal to or higher than a certain pressure.

For example, after the closing, the wading control method may further include: performing the wading function; and when it is determined that the wading is ended, by the controller, removing moisture in an air supply system by driving an air compressor.

For example, the removing of the moisture in the air supply system may include: removing moisture in the air supply system while waiting a certain time before driving the air compressor; and removing remaining moisture in the air supply system by driving the air compressor after a certain time.

For example, the removing of the remaining moisture in the air supply system may be performed by determining remaining moisture in the air supply system by driving the air compressor at a reference rotation speed or less after a certain time, and adjusting a rotation speed of the air compressor depending on the determined remaining moisture.

For example, the removing of the moisture in the air supply system may be performed by opening the air pressure control valve while maintaining the closing of the air cut-off valve.

For example, after the removing of the moisture in the air supply system, the wading control method may further include: opening the air cut-off valve to supply air to the fuel cell stack to generate an output.

Further, in order to achieve one or more objectives of the present disclosure, a wading system of a fuel cell vehicle may include: an air supply system including one or more of an air cut-off valve, an air pressure control valve, and an air compressor; and a controller configured to determine whether the fuel cell vehicle requires a wading function, determine a driving available distance based on the battery state of charge (SOC) when it is determined that the wading function is required, and close one or more of the air cut-off valve and the air pressure control valve in preparation for performing the wading function.

For example, the controller may determine whether wading is possible by comparing the driving available distance and a wading distance based on a navigation or comparing the driving available distance and a user-input wading distance.

For example, when it is determined that wading is impossible, the controller may increase the battery state of charge (SOC) to perform the wading.

For example, after the wading of the fuel cell vehicle is ended, the controller may remove moisture in the air supply system by driving the air compressor.

Although the present disclosure was provided above in relation to examples shown in the drawings, it is apparent to those skilled in the art that the present disclosure may be changed and modified in various ways without departing from the scope of the present disclosure, which is provided in the following claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e. g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

1. A wading control method of a fuel cell vehicle, the wading control method comprising:
determining, by a controller of the fuel cell vehicle, whether the fuel cell vehicle requires a wading operation;
based on a determination that the wading operation is required and based on a state of charge (SOC) of a battery of the fuel cell vehicle, determining, by the controller, a driving available distance of the fuel cell vehicle;
based on the driving available distance and based on a driving route of the fuel cell vehicle, determining, by the controller, whether the wading operation is granted;
based on a determination that the wading operation is granted, closing, by the controller, at least one of an air cut-off valve of a fuel cell stack of the fuel cell vehicle or an air pressure control valve associated with the fuel cell stack; and
after the closing, performing, by the controller, the wading operation while driving the fuel cell vehicle along the driving route.

2. The wading control method of claim 1, wherein the determining whether the wading operation is granted comprises:
comparing the driving available distance with a wading distance associated with the driving route, wherein the wading distance is determined based on the driving route provided by a navigation device provided in the fuel cell vehicle.

3. The wading control method of claim 1, wherein the determining whether the wading operation is granted comprises:
comparing the driving available distance with a user-input wading distance,
wherein the user-input wading distance is an estimated wading distance set by a user of the fuel cell vehicle, and the estimate wading distance is associated with a driving route of the fuel cell vehicle selected by the user.

4. The wading control method of claim 1, wherein the determining whether the wading operation is granted comprises:
based on a determination that the wading operation is prohibited, charging the battery to increase the SOC of the battery for the wading operation.

5. The wading control method of claim 1, wherein the closing comprises:
closing the air pressure control valve and pressurizing the fuel cell stack by driving an air compressor for preparing the wading operation; and
after the pressurizing the fuel cell stack, closing the air cut-off valve and stopping driving of the air compressor.

6. The wading control method of claim 5, wherein the closing of the air cut-off valve comprises:
closing, based on an inner pressure of the fuel cell stack satisfying a set pressure value, the air cut-off valve.

7. The wading control method of claim 1, further comprising:
after the closing, performing the wading operation; and
after the wading operation is ended, removing, by the controller, moisture from an air supply system of the fuel cell vehicle.

8. The wading control method of claim 7, wherein the removing of the moisture from the air supply system comprises:
removing moisture from the air supply system for a time duration before driving an air compressor; and
after the time duration, removing remaining moisture from the air supply system by driving the air compressor.

9. The wading control method of claim 8, wherein the removing of the remaining moisture from the air supply system comprises:
determining the remaining moisture in the air supply system by driving the air compressor at a reference rotation speed after the time duration, and
adjusting, based on the determined remaining moisture, a rotation speed of the air compressor.

10. The wading control method of claim 7, wherein the removing of the moisture from the air supply system comprises opening the air pressure control valve while maintaining the closing of the air cut-off valve.

11. The wading control method of claim 7, further comprising:
after the removing of the moisture from the air supply system, opening the air cut-off valve to supply air to the fuel cell stack to generate an output power by using the fuel cell stack.

12. An apparatus of a fuel cell vehicle, the apparatus comprising:
an air supply system comprising at least one of:
an air cut-off valve of a fuel cell stack of the fuel cell vehicle,
an air pressure control valve associated with the fuel cell stack, or
an air compressor associated with the fuel cell stack; and
a controller configured to:
determine whether the fuel cell vehicle requires a wading operation,
based on a determination that the wading operation is required and based on a state of charge (SOC) of a battery of the fuel cell vehicle, determine a driving available distance of the fuel cell vehicle, and
based on a determination that the wading operation is granted, close at least one of the air cut-off valve or the air pressure control valve in preparation for performing the wading operation within the driving available distance.

13. The apparatus of claim 12, wherein the controller is configured to determine whether the wading operation is granted by:
comparing the driving available distance with a wading distance associated with a driving route of the fuel cell vehicle, wherein the wading distance is determined based on the driving route provided by a navigation device provided in the fuel cell vehicle; or
comparing the driving available distance with a user-input wading distance, wherein the user-input wading distance is an estimated wading distance set by a user of the fuel cell vehicle, and the estimate wading distance is associated with a driving route of the fuel cell vehicle selected by the user.

14. The apparatus of claim 13, wherein the controller is configured to charge, based on a determination that the wading operation is prohibited, the battery to increase the SOC of the battery to perform the wading operation.

15. The apparatus of claim 12, wherein the controller is configured to remove, after the wading operation is ended, moisture from the air supply system by driving the air compressor.

16. The apparatus of claim 12, wherein the controller is configured to:
during a first time period, close the air pressure control valve and pressurize the fuel cell stack by driving the air compressor for preparing the wading operation; and
during a second time period after the first time period, close the air cut-off valve while maintaining the closing of the air pressure control valve, wherein the wading operation is performed during the second time period.

17. A vehicle comprising:
a first power source comprising a fuel cell stack;
a second power source comprising a battery;
an air supply system comprising at least one of:
a first valve configured to cut-off air supply to the fuel cell stack, or
an air pressure control valve associated with the fuel cell stack; and
a controller configured to:
based on a determination that a wading operation is required for the vehicle and based on a state of charge (SOC) of the battery, determine a driving available distance of the vehicle, and
based on a determination that the wading operation is granted, close at least one of the first valve or the air pressure control valve in preparation for performing the wading operation within the driving available distance.

18. The vehicle of claim 17, wherein the controller is configured to charge, based on a determination that the wading operation is prohibited, the battery to increase the SOC of the battery to perform the wading operation.

19. The vehicle of claim 17, wherein the controller is configured to remove, after the wading operation is ended, moisture from the air supply system by driving an air compressor.

20. The vehicle of claim 17, wherein the controller is configured to:
during a first time period, close the air pressure control valve and pressurize the fuel cell stack by driving an air compressor for preparing the wading operation; and
during a second time period after the first time period, close the first valve while maintaining the closing of the air pressure control valve, wherein the wading operation is performed during the second time period.
